(19) United States
(12) Patent Application Publication
(10) Pub. No.: US 2023/0330782 A1
(43) Pub. Date: Oct. 19, 2023

(54) DEVICE FOR MACHINING A MATERIAL

(71) Applicant: TRUMPF Laser GmbH, Schramberg (DE)

(72) Inventors: Daniel Grossmann, Schramberg (DE); Malte Kumkar, Weimar (DE)

(21) Appl. No.: 18/337,079

(22) Filed: Jun. 19, 2023

Related U.S. Application Data
(63) Continuation of application No. PCT/EP2021/084561, filed on Dec. 7, 2021.

(30) Foreign Application Priority Data
Dec. 21, 2020 (DE) 10 2020 134 367.1

(51) Int. Cl. B23K 26/0622; B23K 26/064; B23K 26/38

(52) U.S. Cl. CPC B23K 26/38; B23K 26/0624; B23K 26/064

(57) ABSTRACT

A device for machining a material using ultrashort laser pulses from a laser beam includes an input coupling system comprising an input coupling optical unit, a rotary system connected to the input coupling system and rotatable about an axis of rotation, and a machining optical unit connected to the rotary system and capable of being rotated together therewith and configured for guiding the laser beam into or onto the material to be machined. The input coupling optical unit is configured such that a laser beam is guided into a corresponding machining plane. A rotary optical unit of the rotary system and the machining optical unit are configured such that the corresponding machining plane is guided into a machining plane of the material to be machined. The device further includes a beam influencing system for positioning and/or shaping the laser beam in the corresponding machining plane.

### CROSS REFERENCE TO RELATED APPLICATIONS

This application is a continuation of International Application No. PCT/EP2021/084561 (WO 2022/135908 A1), filed on Dec. 7, 2021, and claims benefit to German Patent Application No. DE 10 2020 134 367.1, filed on Dec. 21, 2020. The aforementioned applications are hereby incorporated by reference herein.

### FIELD

Embodiments of the present invention relate to a device for machining and in particular for microstructuring a material by means of ultrashort laser pulses from an ultrashort pulse laser, in particular for use with a machining optical unit having a high numerical aperture.

### BACKGROUND

Microstructuring processes using ultrashort laser pulses from an ultrashort pulse laser and using a machining optical unit having a large numerical aperture are usually very limited in terms of the throughput and the process speed. For machining over a large surface area and in particular microstructuring of a material, in addition systems such as polygon scanners cannot, or can only in exceptional cases, be used in applications with optical units having a large numerical aperture.

EP 2 359 193 B1 discloses rotatable optical sweeping devices which make it possible to carry out microstructuring processes over a surface area.

### SUMMARY

Embodiments of the present invention provide a device for machining a material using ultrashort laser pulses from a laser beam of an ultrashort pulse laser. The device includes an input coupling system that is stationary in relation to an axis of rotation and comprises an input coupling optical unit for input coupling the laser beam, a rotary system that is connected to the input coupling system so as to be rotatable about the axis of rotation and comprises a rotary optical unit, and a machining optical unit that is connected to the rotary system and capable of being rotated together therewith, and is configured for guiding the laser beam into or onto the material to be machined. The input coupling optical unit is configured such that a laser beam input coupled into the input coupling optical unit is guided into a corresponding machining plane. The rotary optical unit and the machining optical unit are configured such that the corresponding machining plane is guided into a machining plane of the material that is to be machined. The device further includes a beam influencing system for positioning and/or shaping the laser beam in the corresponding machining plane, wherein the beam influencing system is arranged upstream of and/or in the input coupling system.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic structure of the device according to some embodiments;

FIG. 2 shows a detailed view of the structure of the device according to some embodiments;

FIGS. 3A and 3B show various embodiments of the rotary system;

FIG. 4 shows the machining area of the rotary system in conjunction with a beam influencing system according to some embodiments;

FIG. 5 shows the machining area of the rotary system in conjunction with the beam influencing system and a feed device according to some embodiments;

FIGS. 6A, 6B, 6C, 6D, 6E, and 6F show a detailed view of a possible machining strategy according to some embodiments;

FIGS. 7A and 7B show a schematic illustration of a Schwarzschild objective lens and imaging elements in a rotary optical unit according to some embodiments;

FIG. 8 shows a schematic illustration of the device with two different beam paths according to some embodiments;

FIGS. 9A and 9B show a schematic illustration of a deflection optical unit for a multiplicity of beam paths according to some embodiments;

FIGS. 10A and 10B show a schematic illustration of the device with a scanner optical unit;

FIGS. 11A and 11B show a schematic illustration of the device for machining materials which are cylindrical in certain portions according to some embodiments; and

FIG. 12 shows a schematic illustration of the device with an axicon.

### DETAILED DESCRIPTION

Embodiments of the present invention provide a device for machining a material by means of ultrashort laser pulses from a laser beam of an ultrashort pulse laser, preferably for introducing microstructures into the material, comprising an input coupling system which is stationary in relation to an axis of rotation and has an input coupling optical unit for input coupling the laser beam, a rotary system which is connected to the input coupling system so as to be rotatable about the axis of rotation and has a rotary optical unit, and a machining optical unit which is connected to the rotary system, can be rotated together therewith, and is intended for imaging the laser beam into or onto the material that is to be machined, wherein the input coupling optical unit is designed such that a laser beam input coupled into it is guided into a corresponding machining plane, and wherein the rotary optical unit and the machining optical unit are designed such that they image the corresponding machining plane into the machining plane of the material that is to be machined. According to embodiments of the invention, a beam influencing system for positioning and/or shaping the laser beam in the corresponding machining plane is arranged upstream of and/or in the input coupling system.

The ultrashort pulse laser in this case makes ultrashort laser pulses available. In this context, ultrashort can mean that the pulse length is for example between 500 picoseconds and 10 femtoseconds, in particular between 20 picoseconds and 50 femtoseconds. The ultrashort pulse laser may also make available bursts composed of ultrashort laser pulses, each burst comprising the emission of a plurality of laser pulses.

The interval between the laser pulses may be between 100 nanoseconds and 10 microseconds in this respect. A temporally shaped pulse which has a significant change in amplitude within a range of between 50 femtoseconds and 5 picoseconds is also considered to be an ultrashort laser pulse. The term pulse or laser pulse is used repeatedly in the following text. This also includes laser pulse trains, comprising multiple laser pulses having a repetition frequency between 100 MHz and 50 GHz, and temporally shaped laser pulses, even if this is not explicitly stated in each case. The ultrashort laser pulses emitted by the ultrashort pulse laser accordingly form a laser beam.

The ultrashort pulse laser is preferably in the form of a stationary system. Since the rotary optical unit, by contrast to the laser, is movable, the input coupling system with the input coupling optical unit takes on the task of introducing the laser beam from the stationary laser into the rotary optical unit. The input coupling system is in this respect kept stationary in relation to the axis of rotation, which in particular can mean that the input coupling system does not rotate conjointly with the rotary system.

The stationary input coupling system comprises an input optical unit, which may comprise an arrangement of one or more lenses and/or mirrors and takes on the task of imaging the laser beam, provided by the ultrashort pulse laser, into an image-side optical intermediate plane, what is referred to as the corresponding machining plane.

The input coupling optical unit may furthermore comprise beam shaping or beam deflecting elements, wherein the beam influencing brought about by these elements is imaged into the corresponding machining plane by the input coupling optical unit.

The rotary system adjoins the input coupling system. The rotary system and the input coupling system are rotatably connected to one another. Since the input coupling system is kept stationary, the rotary system at least in certain portions can move about an axis of rotation defined by the input coupling system. The beam propagation direction may correspond to the axis of rotation in this respect. The axis of rotation may, however, also be offset parallel to the beam propagation direction, or be tilted with respect to the beam propagation direction, it possibly being necessary to adapt the focussing depending on the rotation angle. Rotatable/rotatably can mean that the rotary system can be rotated by at least 360° or any desired multiple thereof. However, this does not rule out pivoting about the input coupling system in a certain delimited angle range, in particular the rotary system can also oscillate at smaller angles than 360° and thus perform only a back-and-forth pivoting movement.

A rotatable attachment makes it possible for the rotary system to pivot or rotate about the axis of rotation and at the same time ensures secure retention and secure guidance of the rotary system during the rotation. In this respect, the rotatable attachment may be realized, for example, by a ball bearing. This reduces the friction between the rotary system and the input coupling system. However, other, preferably low-friction, attachments are also possible.

The rotary system has a rotary optical unit. The rotary optical unit may have a multiplicity of lenses or mirrors in this respect. The rotary optical unit transfers substantially the image-side intermediate plane, that is to say the corresponding machining plane, to the object-side intermediate plane of the machining optical unit. In other words, the rotary optical unit here may act as an extension of the beam path and transfer the corresponding machining plane, together with the machining optical unit, in the direction of the workpiece.

For example, the rotary optical unit may comprise a deflection optical unit, by means of which the laser beam is deflected from the corresponding machining plane of the input coupling optical unit to the rotary system. The rotary optical unit may furthermore comprise one lens or multiple lenses, wherein the object-side focus of the rotary optical unit coincides with the corresponding machining plane of the input coupling optical unit. The rotary optical unit may furthermore comprise an output coupling mirror, which deflects the laser beam from the rotary system towards the machining optical unit.

The machining optical unit adjoins the rotary system. The machining optical unit and the rotary system are connected to one another. The connection may, for example, be a screw, click-in or plug-in connection. The machining optical unit may be an objective lens or an arrangement of lenses and/or mirrors, wherein the machining optical unit images the corresponding machining plane of the input coupling optical unit into the machining plane, into or onto the material, by way of the rotary optical unit. In other words, the system composed of the rotary optical unit and the machining optical unit images the corresponding machining plane, which is provided by the input coupling optical unit, onto the actual machining plane in the material that is to be machined.

In the mathematical ideal case, that is to say in the case of a single punctiform focus, the machining plane is a plane which is perpendicular to the beam propagation direction and which preferably extends parallel to the surface of the material that is to be machined and in which the material is intended to be machined. In particular, in the machining plane sharp imaging of the corresponding machining plane is possible. Accordingly, the machining plane always relates to the machining optical unit. However, in practical implementation, the optical elements in the beam path lead to minor curvatures and distortions of the machining plane, with the result that the machining plane is usually at least locally curved. Moreover, the focus of the laser beam resulting from the machining optical unit also has an endless volume, in which the microstructures can be introduced into the material. In particular, the focal region also extends in the beam propagation direction, with the result that a machining volume is actually produced instead of a machining plane. The machining plane may moreover also be deliberately curved, in order for example to enable three-dimensional machining of the material, or to enable machining on a curved surface. The machining plane is therefore to be understood overall as the volume of the space in which the realizable imaging of the laser beam makes it possible to introduce microstructures into the material. In this case, the alignment of this volume is given relative to the propagation direction of the laser beams, albeit to a good approximation, by alignment of the mathematical machining plane. Therefore, reference is always made to the machining plane below, although consideration is always also given to the accessible machining volume, even if this is not explicitly mentioned.

In particular, the term “focus” can be understood to mean, in general, a targeted intensity boost, with the laser energy converging in a “focal region”. In particular, the term “focus” is therefore used below independently of the beam shape actually used and the methods for bringing about an intensity boost. The location of the intensity boost along the beam propagation direction can also be influenced by “focusing”. By way of example, the intensity boost can be virtually punctiform and the focal region can have a Gaussian intensity cross section, as provided by a Gaussian laser beam. The intensity boost can also have a linear form, with a Bessel-type focal region arising around the focal position, as may be provided by a nondiffractive beam. Moreover, other, more complex beam shapes are also possible, the focal position of which extends in three dimensions, for example a multi-spot profile made of Gaussian laser beams and/or non-Gaussian intensity distributions. The extent of the machining of material depends on the position of the focus of the machining optical unit, among other things, in this respect. Here, the focus comprises the volume in the space in which the energy of the laser is made to converge by the machining optical unit and in which the laser energy density is high enough to introduce microstructures into the material. In particular, the laser beam can be imaged onto or into the material. This can mean that the focus of the laser beam resulting from the machining optical unit is located above the surface of the material, or located exactly on the surface of the material, or located within the volume of the material.

The laser beam is at least partly absorbed by the material, with the result that the material for example is heated thermally or transitions into a temporary plasma state and evaporates, or a modification is made in the material that changes the local binding structure or density, and is machined as a result. In particular, instead of linear absorption processes, it is also possible to use non-linear absorption processes, too, which become accessible through the use of high laser energies. Machining of material may consist in microstructuring of the material, for example. Microstructuring can mean that one-dimensional, two-dimensional, or three-dimensional structures or patterns or modifications of material are intended to be made in the material, with the size of the structures typically at least having a dimension measured in micrometres, or the resolution of the structures being of the order of the wavelength of the laser light that is used. For example, a Bessel-like beam may have a longitudinal extent measured in millimetres.

While the ultrashort pulse laser provides the ultrashort laser pulses and the machining optical unit images the shaped pulses from the corresponding machining plane into or onto the material, the rotary system rotates about the input coupling optical unit. This rotation takes place with an angular velocity about the axis of rotation defined by the input coupling optical unit.

This has the effect that the shaped laser pulses are introduced into the material at a multiplicity of positions, and therefore a high machining density of the material can be achieved.

By providing the beam influencing system upstream of and/or in the input coupling system, it is possible to have the effect of positioning and/or shaping the laser beam in the corresponding machining plane. In this way, micropositioning of the beam focus can be achieved both in the plane which lies through the surface of the material that is to be machined and in terms of the focal position in the beam direction.

Upstream of the input coupling optical unit can mean that the beam is influenced before it is introduced into the input coupling system. In particular, the beam influencing system can therefore be connected upstream of the input coupling system. In the input coupling system can mean that the beam influencing system influences the laser beam after the laser beam has been coupled into the input coupling system. Upstream of and in the input coupling system can mean that the beam influencing system has multiple stages and the laser beam for example is influenced for the first time upstream of the input coupling system and is influenced anew in the input coupling system. However, in this respect each stage can be considered to be an individual beam influencing system. It may also be the case, however, that the beam influencing system acts as one unit upstream of and in the input coupling system.

The beam influencing system may in this respect also influence the shape of the incident laser beam. For example, it may influence the beam profile of the laser beam. For example, a flat-top beam profile can be generated from a Gaussian beam profile. A lateral beam profile, that is to say the intensity distribution of the laser beam in the plane perpendicular to the beam propagation direction, may for example however also have an elliptical or triangular or linear or other shape.

The beam influencing system may however also modify the propagation direction of the laser beam by deflecting the incident laser beam. In particular, the beam influencing system can also displace the incident laser beam parallel to its original propagation direction in the machining plane of the machining optical unit, that is to say impose a spatial parallel offset on the laser beam there.

In other words, the beam influencing system, the rotary optical unit and the machining optical unit can be used to realize an operating area, in which the laser beam can be freely positioned, in the machining plane by means of the machining optical unit in accordance with the respective technical specifications, such as the focal widths and enlargements, if present, and further imaging properties, such as the maximum deflection brought about by the beam influencing system. The operating area in the machining plane may for example have an extent of 2 to 500 times a beam diameter of the laser beam that can be achieved in this machining plane.

In this way, the beam influencing system can be used to have the effect of displacing the beam position in the corresponding machining plane and thus also displacing the position of the focussed beam on the material that is to be machined after it has been imaged onto the material that is to be machined. Therefore, it is correspondingly possible, in addition to the movement of the rotary optical unit and thus the movement of the machining optical unit over the material, to impose further positioning on the laser beam which machines the material. In this way, it is correspondingly possible to control further positions in the material, with the result that, depending on the geometric position predefined by the rotational movement of the rotary system and a feed between the material and the device, other points on the material can also be controlled.

The beam influencing system may furthermore also shape the laser beam to the effect that the further spatial configuration of the intensity distribution of the laser beam is adapted. This shaping can include, for example, the generation of partial beams from the incident laser beam by the beam influencing system and the possibility of setting a distance between them. The laser beam can preferably be split up into at least two partial laser beams, with the result that the number of laser beams that can be used for the machining of material is correspondingly multiplied. A shaping of the laser beam that comprises multiple partial laser beams is also referred to as multispot geometry.

The partial laser beams are preferably introduced into the material synchronously, or at the same time. This enables additional optimization of the heat accumulation when material is being machined. Temporally synchronized introduction of the laser pulses of the partial laser beams makes it possible to maximize the time interval between successive pulses in order to minimize the input of heat from the laser into the material. On the other hand, it is also possible to achieve an enhanced action at high spatial resolution with a single pulse.

The partial laser beams may be introduced into the material in particular next to one another and/or at different introduction depths. In particular, this means that the partial laser beams are not in line. If there are more than two partial laser beams, this can mean that all partial laser beams are located on a line, in particular a straight line. However, it can also mean that the arrangement of the partial laser beams requires two dimensions. For example, the partial laser beams may be arbitrarily arranged in a circular shape or rectangular shape or chequerboard pattern. The partial laser beams may also be in line and overlap one another and the partial laser beams may be introduced into the material at different introduction depths. In particular, the partial laser beams may also be arbitrarily arranged in three dimensions. In particular, the partial laser beams may also be positioned in three dimensions. For example, in the event of a curved machining plane, the beam influencing system can also enable a displacement of the focus for each partial laser beam.

The beam influencing system may in particular also be a pure beam shaping system or a multiplexing system for generating partial laser beams. In particular, the beam influencing system could also generate nondiffractive beam profiles, such as Bessel beams or Gaussian-Bessel beams and/or other beams, for example laterally shaped laser beams, that is to say laser beams shaped perpendicularly in relation to the propagation direction. The intensity profiles can for example be configured by a diffractive optical element or an axicon. Here, a machining geometry describes all of the beam properties in the operating area.

For example, a machining geometry may comprise a grid of 5×5 partial laser beams, all of which have the same beam profile or different beam profiles. In particular, a machining geometry may be provided by the arrangement of partial laser beams in what is referred to as a multispot profile. However, a machining geometry also includes the properties, for example the position, the intensity and the beam profile, of the individual partial laser beams, or laser beams.

Each partial laser beam may also be referred to as element of the machining geometry in this respect. For example, a star-shaped beam profile is a machining geometry. A round and a star-shaped beam profile in the operating area are also a machining geometry. Both the round and the star-shaped laser beam are elements of the machining geometry. If the position of at least one of the two elements is changed, the machining geometry overall is also changed. If the beam profile of an element is changed, the machining geometry is likewise changed. A machining geometry is generally also provided by a single laser beam in the operating area.

The beam influencing system may comprise a beam shaping element and/or a beam positioning element, which is arranged in the region of the corresponding machining plane.

This makes it possible to effectively influence the beam.

The laser may preferably be operated in its fundamental mode and/or the laser beam may be a coherent superposition of multiple modes of the laser, wherein the beam quality factor M² is less than 1.5.

The mode of the laser is established here by the resonator of the laser, wherein the fundamental mode of the laser is typically referred to as TEM00 and TEM stands for transverse electric mode. In this respect, in the ideal case the fundamental mode corresponds to the Gaussian beam shape, wherein a superposition of this fundamental mode with higher modes from the spectrum of the resonator can lead to a deviation of the beam shape of the laser beam from the Gaussian beam shape. The deviation, that is to say the beam quality factor, is measured as the quotient of the angle of divergence of the actual laser beam from an ideal Gaussian laser beam, wherein the angle of divergence is given by the opening angle of the envelope of the laser beams given the same beam waist.

The normal of the machining plane may be inclined by less than 10° with respect to the axis of rotation. Preferably, however, it is not inclined with respect to the axis of rotation, in particular in that case it is aligned parallel to the axis of rotation.

This can have the effect that the machining plane can be moved over the material in a circular ring.

The normal of the machining plane may be aligned perpendicularly in relation to the axis of rotation.

This can have the effect that the machining plane sweeps over the lateral surface, in particular the inner lateral surface, of a cylinder. Consequently, the device is suitable for the machining of cylindrically symmetrical surfaces.

The beam influencing system may enable a redistribution of the intensity distribution in the corresponding machining plane in such a way that a higher intensity can be obtained in partial regions within the machining plane than would be possible without the beam influencing system.

This makes it possible to machine the material with a higher intensity.

The beam influencing system may comprise a beam shaping element and/or a beam positioning element and/or a focus displacing element, which is not arranged in the corresponding machining plane.

This arrangement leads to it being possible for a redistribution of the energy of the incident laser beam in the corresponding machining plane to take place and thus the lateral extent of the laser beam striking the beam influencing system significantly decreases, for example at least by a factor of 5, the energy stays the same and the intensity increases, for example at least by a factor of 5.

Furthermore, this arrangement makes it possible to have the effect that the energy impinging on the beam influencing element per surface area can be reduced and therefore damage to the beam influencing element can be reduced or avoided.

The beam influencing system may moreover induce a coherent superposition of individual laser beams, in particular of partial laser beams. The beam influencing system may preferably comprise an acousto-optic deflector unit, wherein an acousto-optic deflector unit consists of one or more acousto-optic deflectors.

In the case of an acousto-optic deflector, an AC voltage is used to generate, at a piezo crystal in an optically adjacent material, an acoustic wave, for example in the form of a wave packet, a propagating wave or a standing wave, that periodically modulates the refractive index of the optical material. Owing to the periodic modulation of the refractive index, a diffraction grating for an incident laser beam is realized here. An incident laser beam is diffracted at the diffraction grating and consequently deflected at least in part at an angle to its original beam propagation direction. The grating constant of the diffraction grating and hence the deflection angle in this case depend, among other things, on the wavelength of the lattice vibration and thus on the frequency of the AC voltage applied. By way of example, deflections of the laser beam in the x and y directions can thus be produced by way of a combination of two acousto-optic deflectors in the deflector unit.

In a preferred embodiment, the beam influencing system generates a Bessel or Bessel-like beam, with the result that it actually or virtually passes through the corresponding machining plane.

Since the beam influencing system is arranged upstream of and/or in the input coupling system, it is not conjointly rotated. It therefore generates images of the influenced laser beam in its image-side focus that are positionally fixed, that is to say stationary in relation to the axis of rotation, disregarding imaging errors. The image-side focus of the beam influencing system may in particular coincide with the corresponding machining plane, with the result that positioning and/or shaping of the laser beam in the corresponding machining plane is achieved. As a result, the influenced laser beam is then correspondingly imaged into the machining plane, into or onto the material.

Since the beam influencing system does not conjointly rotate, but the image from the beam influencing system in the rotary optical unit is deflected by a mirror optical unit and conjointly rotates therewith, an image of the non-rotated corresponding machining plane appears offset in or on the material. In particular, the operating area is guided over the material in a circular path by this operation, in the coordinate system the non-rotated input coupling system, wherein the operating areas may spatially overlap at two different times. Quick actuation of the acousto-optic deflector unit makes it possible to compensate for an overlap by adapting the beam shape, produced by the beam influencing system, in accordance with the angular velocity of the rotary system and with the instantaneous angular alignment. In particular, as a result the various elements of a machining geometry, such as partial laser beams, can be resorted in the operating area by quick actuation, with the result that the microstructures are not inadvertently introduced into the material multiple times.

Preferably, the beam influencing system is designed such that positioning and/or shaping of the laser beam precisely for each pulse is achieved in the corresponding machining plane and preferably focus positioning or beam shaping precisely for each pulse is achieved in the machining plane of the material that is to be machined.

The focus positioning and shaping of the machining geometry, or of the laser beams, precisely for individual pulses in combination with a suitable overlap of the operating areas with a combined relative movement between the optical unit and the material by rotation and advancement, make it possible to freely machine materials, while the rotation causes the operating area to be guided over the workpiece in a circular ring or circular ring segment.

Preferably, the machining optical unit comprises a high NA objective lens, preferably having a numerical aperture greater than 0.1, preferably having a numerical aperture greater than 0.2, or a Schwarzschild objective lens, which can be adapted in the focal position preferably by a focussing device, preferably a piezo shifter.

The numerical aperture NA describes the ability of an optical element to focus light. In this respect, the numerical aperture results from the opening angle of the marginal rays of the objective lens and the refractive index of the material between the objective lens and the focal spot. A maximum numerical aperture is achieved when the opening angle between the marginal ray and the optical axis is 90°. The maximum resolution, or the maximum structure size, that can be imaged by the objective lens is then directly proportional to the wavelength of the laser light divided by the numerical aperture.

A high NA objective lens is accordingly an objective lens which has a high numerical aperture, that is to say a large opening angle. This makes it possible to introduce microstructures into the material with high resolution using a high NA objective lens. Preferably, the numerical aperture is greater than 0.1, preferably greater than 0.2.

A Schwarzschild objective lens is an optical component which, by contrast to the conventional objective lens, is not based on diffraction and refraction of radiation by an optical element, for example a lens. In the case of the Schwarzschild objective lens, the imaging property is achieved by a mirror structure, specifically the combination of a convex mirror and a concave mirror. In particular, the numerical aperture is achieved by the curvature of the concave mirror, in a similar way to a reflecting telescope. The advantage of the Schwarzschild objective lens is firstly that, given a high numerical aperture and also a moderate input beam diameter, a larger operating distance between the objective lens and the material can be produced. Furthermore, use is made of reflective components, with the result that the light does not need to pass through a lens in order for its propagation direction to be modified. The latter is advantageous in particular in the event of UV applications or deep UV applications, in which otherwise most of the laser energy would be absorbed by the lenses, which can thus lead to a thermally induced influence on the quality and/or to deterioration of the optical unit in addition to a reduction in the efficiency. Therefore, a Schwarzschild objective lens is suitable in particular for application with boosted laser power, such as in the case of the production of microchips in for example lithographic or microlithographic processes.

A focussing device of the objective lens may for example be mounted between the rotary system and the machining optical unit. Preferably, however, the focussing device is arranged in the non-rotating part. A focussing device can be used to change the path between the machining optical unit and the material surface. This makes it possible to generate a sharp image of the corresponding machining plane.

A focussing device may for example be a piezo shifter. A piezo shifter is a piezoelectronic component which changes its geometric extents when an electrical voltage is applied to it. The application of a voltage to the piezo shifter thus makes it possible to vary a thickness, for example. If the thickness of the piezo shifter is part of the path between the objective lens and the material surface, the piezo shifter makes it possible to establish the position of the focus on or in the material. A focussing device may, however, also be provided by a TAG lens, a piezo deformable mirror or by an acousto-optic deflector.

By virtue of the focussing device, it is therefore possible to ensure a sharp imaging of the laser beam into the desired machining plane.

Overall, the device with the beam influencing system and the high NA machining optical unit makes it possible to scale micromachining processes, which are necessary for small structure sizes and/or high resolution, to extensive machining of material using high machining velocities.

The rotary system may have an areal design, preferably in the form of a cylinder, or an arm-shaped design.

An areal rotary system may for example be a disc, wherein the diameter of the disc perpendicularly to the axis of rotation is larger than the thickness of the disc along the axis of rotation. For example, the diameter may be 10 times or 100 times larger than the thickness. In particular, the axis of rotation may run through one of the points of symmetry of the disc, in particular through a point in which the shape of the disc is characterized by rotational symmetry. In particular, the disc, starting from the point of symmetry, may have a small unbalance and have a constant mass distribution in a radial direction. In addition, a disc-shaped configuration makes it possible to reduce air resistances and reduce disruptive turbulences, provided that work is not performed at a correspondingly great negative pressure. In particular, the disc may be a cylinder, the thickness of which is considerable smaller than the diameter, with the axis of rotation running through the centre point of the disc. In particular, the machining optical unit may be mounted on the areal rotary system, with the result that the machining optical unit protrudes from the surface of the rotary system. The machining optical unit may, however, also be integrated in the rotary system.

An arm-shaped rotary system may be provided by an arm, with the length of the arm being greater than the sides of its cross section. The axis of rotation may run through the centre point of the longitudinal axis of the arm, as a result of which a corresponding unbalance is reduced. The axis of rotation may, however, also run through another point of the longitudinal axis, in particular through an end point of the longitudinal axis.

The rotary optical unit may be integrated in the disc or in the arm and in particular run in a corresponding cavity in the disc or in the arm. However, it may also be the case that the rotary optical unit is fastened on or below the disc or the arm. In any case, corresponding balancing weights on the disc or the arm make it possible to reduce the unbalance caused by the rotary optical unit and machining optical unit.

The rotary optical unit may contain imaging mirror and/or lens optical units. The rotary optical unit may, however, also comprise beam shaping elements, such as a diffractive optical element or an axicon.

Imaging mirror optical units are mirrors of which the surface has a curvature. Such a curvature makes it possible to generate images, or the imaging scale can be changed, for example enlarged or reduced in size. The same applies to lens optical units.

Since the rotary optical unit contains an imaging mirror and/or lens optical unit, the corresponding machining plane can be imaged into the machining plane with an enlargement or reduction in size. In particular, this makes it possible to change the structure size of the microstructures.

The rotary optical unit may comprise a telescope, preferably a relay telescope, which together with the machining optical unit images the corresponding machining plane of the input coupling system into the machining plane, onto or into the workpiece, preferably with a reduction in size.

A telescope is an arrangement of mirrors and/or lenses which have an imaging or focussing property. In particular, an imaging property is provided by an enlargement or reduction in size of the corresponding machining plane.

A relay telescope is in particular an arrangement of imaging elements which serve to lengthen the optical path of an imaging optical unit, for example the input coupling optical unit, or to invert the image.

The telescope, together with the machining optical unit, images the corresponding machining plane onto or into the workpiece with enlargement or reduction in size, In the process, the focussing is performed by an objective lens having a high numerical aperture, which can be adapted in the focal position for example by means of phase-shifters.

A feed device makes it possible to displace the laser beam, or the input coupling system with the rotary system, and the material relative to one another with a feed.

A feed device may for example be in the form of an XY or XYZ table or a roll-to-roll system. This makes it possible to displace the laser beam and the material relative to one another, wherein the relative displacement can also relate to a static part of the device, that is to say the input coupling system of the device, instead of to the laser beam. In this respect, a superposed movement of the rotation and the feed takes place.

Relative displacement means that the feed or the offset is brought about by a feed device, which moves either the material or else the device, in particular the input coupling system, in one of the spatial directions. In particular, the feed is associated with a feed velocity, with the feed moving along a feed trajectory. If the input coupling system is displaced with the feed device, the laser beam can be fed to the input coupling optical unit either via a fibre, for example a hollow core fibre, or via a free beam section, for example using a gantry axis system.

A feed device makes it possible to add further degrees of translational freedom to the device, with the result that a larger surface area of the material can be machined with the laser beam by virtue of connection to the rotary device.

The material of a roll-to-roll process can be guided through the machining plane.

In the case of a roll-to-roll process, the material is clamped between two rolls and transported, or displaced along a transport direction, by rotating the rolls.

By displacing the material of a roll-to-roll process through the machining plane, the material can be machined quickly with the device according to embodiments of the invention.

The material may be at least locally cylindrical, the axis of rotation may coincide with the cylinder axis, the machining plane may be adapted to a cylinder surface as a result, and the feed may be oriented parallel to the axis of rotation.

This makes it possible to machine a cylindrical surface.

At least locally cylindrical means that the material needs to be cylindrical only in certain portions, in particular needs to have only one radius of curvature.

For example, in a roll-to-roll process, a film wound up on a roll is unwound for the machining and is wound up again after the machining. In the process, the film for machining may be adapted to a cylinder surface in certain portions, that is to say over a limited length, wherein the cylinder axis then largely corresponds to the axis of rotation, preferably exactly corresponds to the axis of rotation.

Preferably, a control system for synchronizing the control of the beam influencing system, of the rotary system and of the ultrashort pulse laser may be provided, wherein the beam influencing system displaces the machining geometry in the corresponding machining plane such that, provided the operating areas of two successive laser pulses overlap, the structures introduced in or on the material merely complement one another and there are no undesired repeated exposures.

Synchronization means that the control, the beam influencing system, the rotary system and the ultrashort pulse laser and optionally the displacement device have a common time basis. For this, the control device is connected to the pulsed laser system and to the beam influencing system and the rotary system and optionally to the feed device.

Owing to this common time basis, the control can be used to actuate the various systems such that the laser beams can be introduced into the material as desired. For example, the common time basis makes it possible to compensate, for example, time delays in the actuation, etc.

Typically, a corresponding control device is based on an FPGA (Field Programmable Gate Array) with fast linked memories, wherein machining parameters such as focal position, pulse energy or mode (individual pulse or laser burst), being able to be stored for a specific machining operation.

In this case, the control commands, or the execution thereof, are synchronized with, for example, the seed frequency of the laser in all connected devices, wherein the seed frequency is the fundamental pulse frequency of the laser, with the result that a common time basis exists for all components. Correspondingly quick actuation of the pulsed laser, beam influencing system, rotary system and feed device makes it possible to set and modify the precise location, the position of the laser focus on the workpiece, and the pulse energy.

For example, the seed frequency then serves to actuate the beam influencing system, for example to temporally exactly modulate the acousto-optic deflector unit and thus to determine the position of the laser focus. The size and direction of the modulation continue to be provided by the control system here, however.

For example, the exact alignment of the rotary device at any time is known by virtue of a predefined or actuable angular velocity of the rotary device in conjunction with the common time basis.

The precise tuning of the various actuable elements on the basis of the seed frequency consequently allows more accurate control of the machining operation.

The feed device may displace the input coupling system with the rotary system relative to the material parallel to the axis of rotation.

In particular, this makes it possible to sweep over the inner surface of a cylinder, provided the normal of the machining plane is perpendicular to the axis of rotation.

The radius of the rotary system may be adaptable, wherein the rotary optical unit is configured to compensate for the adaptation of the radius in the rotary system.

The radius of the rotary system is provided by the radius of the circular movement of the axis of rotation in relation to the centre point of the machining optical unit.

An adaptable radius of the rotary system can mean that the distance from the machining optical unit to the axis of rotation can be set. For example, the machining optical unit may be positioned closer to or further away from the axis of rotation. This makes it possible to make optimum use of the available material. In particular, the machining optical unit can also be moved during the machining, resulting in a larger operating area for the machining optical unit.

For example, machining can then take plane on the various circular rings, or circle segments. The machining is then no longer limited to a predefined radius, but rather the machining can take place on the surface, which is restricted by the maximum radius of the rotary system.

Since the distance from the machining optical unit to the axis of rotation can be adapted, the optical path between the corresponding machining plane and the machining plane must also be adapted. This can be done using a rotary optical unit, wherein the telescope is configured such that, as a result of a displacement, there is no additional enlargement and further properties, such as the focal position, remain the same. Typically, however, the radius of the rotary system is not dynamically varied during the machining process, although a dynamic change is also possible.

Preferably, the rotary system may have at least two rotary optical units, which are each connected to a dedicated machining optical unit, and the beam influencing system is preferably configured to generate at least two machining geometries, which are each introduced into one of the rotary optical units of the rotary system by a deflection optical unit.

The beam influencing system may in this respect generate multiple machining geometries in parallel or in alternation. For example, the beam influencing system may shape two partial laser beams, wherein the one partial laser beam has a star-shaped beam profile and the other partial laser beam has a rectangular beam profile, wherein the two partial beams are offset parallel to one another by several micrometres, for example 100 µm.

A deflection optical unit may be a mirror system, which deflects one or more partial beams in the direction of a specific machining optical unit. The partial beams are therefore conducted by the deflection optical unit in particular to specific beam paths. The deflection optical unit is part of the rotary system and is thus in particular rotated conjointly.

The device may have multiple machining optical units, wherein each machining optical unit can be reached by way of a specific beam path of the rotary optical unit. In the case of an arm-shaped form of the rotary system, this implies that the rotary system has for example N arms, with N being a natural number. Each machining optical unit has a dedicated machining plane, wherein the corresponding machining plane is generated by the input coupling optical unit. In particular, the beam influencing system provides a multiplicity of different or identical machining geometries in the corresponding machining plane. In particular, in this respect only repositioned machining geometries are included. However, it may also be the case that all machining optical units access the same corresponding machining plane.

Since laser radiation is introduced into the material along a multiplicity of beam paths by a multiplicity of machining optical units, the throughput of the machining of material increases.

The deflection optical unit may be switchable and the machining geometries may be deflected to particular beam paths. In particular, the deflection optical unit may be integrated in or assisted by the beam influencing optical unit.

The deflection optical unit makes it possible to conduct a specific beam geometry to a specific trajectory. Thus can in particular be enabled by synchronization of the rotary system, of the beam influencing system and of the ultrashort pulse laser.

In particular, the deflection optical unit may be switchable, for example implemented by a flip mirror system, as a result of which a laser beam can be conducted either to a first trajectory or to a second trajectory. In particular a switchable deflection optical unit makes it possible to select the trajectories that are available, with the result that the laser beam can be deflected to a particular trajectory. A deflection optical unit may for example also consist in the acousto-optic deflector unit makes available or does not make available the machining geometry at a specific location in the corresponding machining plane.

The beam influencing system may image a machining geometry into a scanner, preferably a 1D or 2D galvanometer scanner, the scanner can move the laser beam and image it in the corresponding machining plane.

In this context, a galvanometer scanner is a deflection device for the laser beam, wherein a parallel offset of the transmitted laser beam in relation to the original laser beam is generated. In particular, a one-dimensional galvanometer scanner deflects the laser beam in only one direction, while a two-dimensional galvanometer scanner deflects the laser beam in two different directions, which are preferably orthogonal in relation to one another.

This makes it possible to have the effect that the circular ring which sweeps over the machining optical unit at a fixed distance in relation to the axis of rotation can be enlarged.

The scanner may, however, also be understood as part of the beam influencing system, since it influences the position of the laser beam. For example, the scanner can therefore be arranged upstream of and/or in the beam influencing system. For example, the laser beam can be deflected by a first acousto-optic deflector unit and then a further position offset can be imposed. For example, the laser beam can also first be deflected by an acousto-optic deflector unit, then conducted through a beam shaping device, and then conducted into a scanner.

Preferred exemplary embodiments are described below with reference to the figures. In this case, elements that are the same, similar or have the same effect are provided with identical reference designations in the different figures, and a repeated description of these elements is omitted in some instances, in order to avoid redundancies.

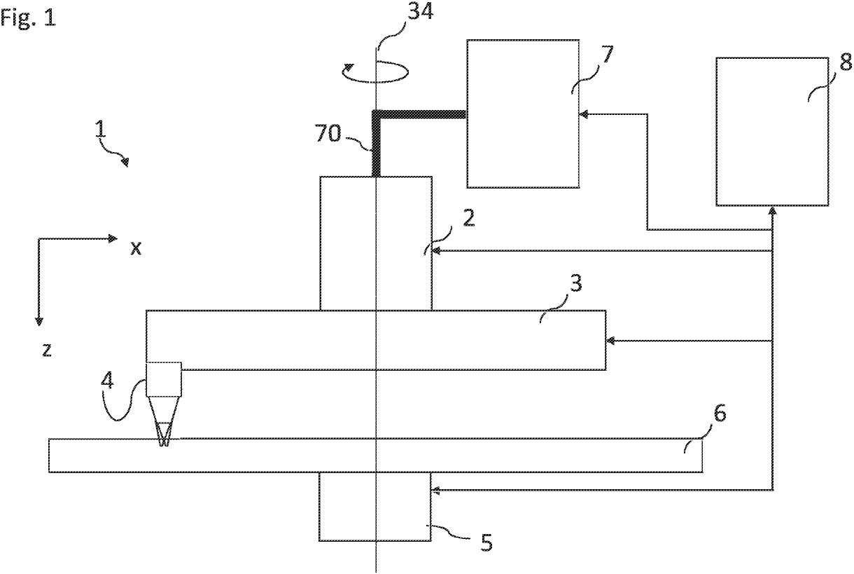

FIG. 1 schematically shows the structure of a device 1 for machining a material 6. An ultrashort pulse laser 7 provided ultrashort laser pulses which form the laser beam 70. The ultrashort laser pulses, or the laser beam 70, are input coupled into the input coupling system 2. The laser pulses pass through the input coupling system 2 and are conveyed into a rotary system 3. The input coupling system 2 and the rotary system 3 are rotationally connected to one another in this case. In particular, the input coupling system 2 is kept stationary in relation to the axis of rotation 34, while the rotary system 3 rotates around the axis of rotation 34 of the rotary system 3. The axis of rotation 34 is predefined by the input coupling system 2, in particular its input coupling optical unit 20, and in this respect the optical axis of the input coupling optical unit 20. In the rotary system 3, the ultrashort laser pulses are conveyed to a machining optical unit 4 and guided by means thereof to the material 6, and there introduced onto the surface and/or into the volume.

The ultrashort laser pulses are at least partially absorbed by the material 6, as a result of which the material 6 can be machined owing to linear or non-linear absorption processes. Machining of material may consist for example in a microstructuring and/or modification of the material 6. The material 6 is in particular connected to a feed device 5 via a material receptacle, as a result of which the material 6 can be displaced relative to the laser beam 70, in particular relative to the input coupling optical unit 20. As an alternative, the material may also be positioned fixedly, with the feed device 5 moving the input coupling system 2 with the rotary system 3 over the material 6 (this is not shown). In any case, the rotary system 3 rotates about the axis of rotation 34 during the feed movement.

The rotation of the rotary optical unit 3 makes it possible to achieve machining of the material 6 over a large surface area by means of a machining optical unit 4, which for example has a high numerical aperture. The machining optical unit 4 is guided on a circle, or in the event of a superposed feed on a spiral path, relative to the material by virtue of the rotation of the rotary optical unit 3. The operating area accordingly sweeps over a circular ring into which the laser light can be introduced. Simultaneous displacement with the displacing device 5 thus makes it possible to add further circle segments or spiral segments to the initial circular ring, in order to ensure extensive machining of the material 6.

The ultrashort pulse laser 7, the input coupling system 2, the rotary system 3 and the feed device 5 can be synchronized with one another by a control system 8. In this context, the seed frequency of the ultrashort pulse laser 7 or another high-frequency signal can serve as common time basis for the synchronization. Since a common time basis is available throughout the system, exact control over the introduction of the laser pulses into the material 6 is possible.

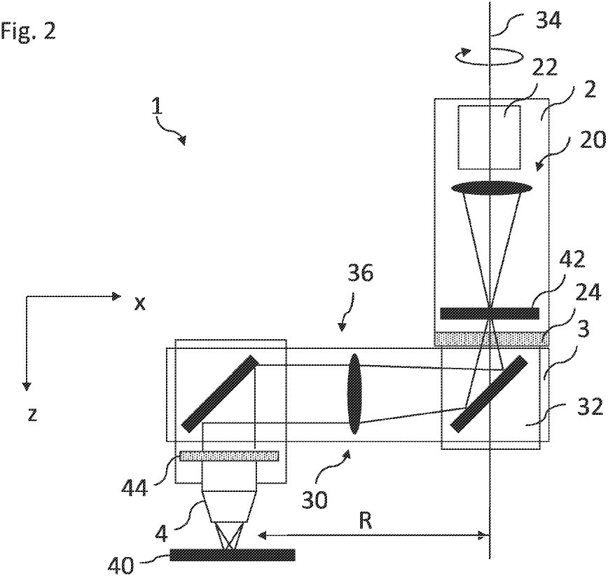

FIG. 2 shows a detailed view of the schematic structure of the device 1, including the beam path. The input coupling system 2 comprises an input coupling optical unit 20. In the exemplary embodiment shown, the input coupling optical unit 20 comprises a beam influencing system 22 which deflects, or modifies, the incident laser beam 70 of the ultrashort pulse laser 7. In another exemplary embodiment, the beam influencing system 22 may also be even further upstream and be arranged outside of the input coupling system 2.

The beam influencing system 22 may in particular be an acousto-optic deflector unit. This unit makes it possible to release the position of each pulse or burst within a small operating area precisely for individual pulses and with a deflection rate of up to several megahertz (random access scan). The operating area here is for example between 2 and 500 beam diameters large, with the result that a relatively small change in position can be carried out, but with a very high velocity. The change in position of each pulse in this respect can be observed in the corresponding machining plane.

A variant to be given particular emphasis in this respect is the displacement of the focal position on the material 6 precisely for individual pulses, even in the beam propagation direction, by using the beam influencing system 22 to correspondingly preshape the laser beam.

The laser beams 70 modified by the beam influencing system 22 are lastly guided into the corresponding machining plane 42. The rotary system 3, in which the laser beam is deflected via a deflection optical unit 32, adjoins the input coupling system 2. The input coupling system 2 and the rotary system 3 are connected to one another via a rotatable connection 24 such that a rotation of the rotary system 3 with respect to the input coupling system 2 is possible and at the same time passage of the laser beam is reliably enabled. The rotary system 3 rotates about the axis of rotation 34 here. The axis of rotation 34 and the beam propagation direction do not have to run parallel to one another. In particular, when the beam has been deflected, the beam propagation direction may differ from the axis of rotation 34.

The rotary system 3 comprises a rotary optical unit 30, which comprises the deflection optical unit 32, a telescope 36 and an output coupling mirror 38. The machining optical unit 43 adjoins the rotary system 3 at a distance R from the axis of rotation 34. The laser beam is deflected from the rotary system 3 to the machining optical unit 4 via the output coupling mirror 38.

Telescope imaging, or 4f imaging, can also be implemented by the machining optical unit 4 in combination with the components arranged in the rotary arm 3.

The machining optical unit 4 in this respect is connected to the rotary system 3 via an optional piezo shifter 44. The piezo shifter 44 makes it possible to focus the laser beam 70 into the machining plane 40 by means of the machining optical unit 4. In particular, imaging of the corresponding machining plane 42 of the beam influencing system 22 into the machining plane 40, in or on the material 6, is possible owing to the telescope 36 in conjunction with the machining optical unit 4.

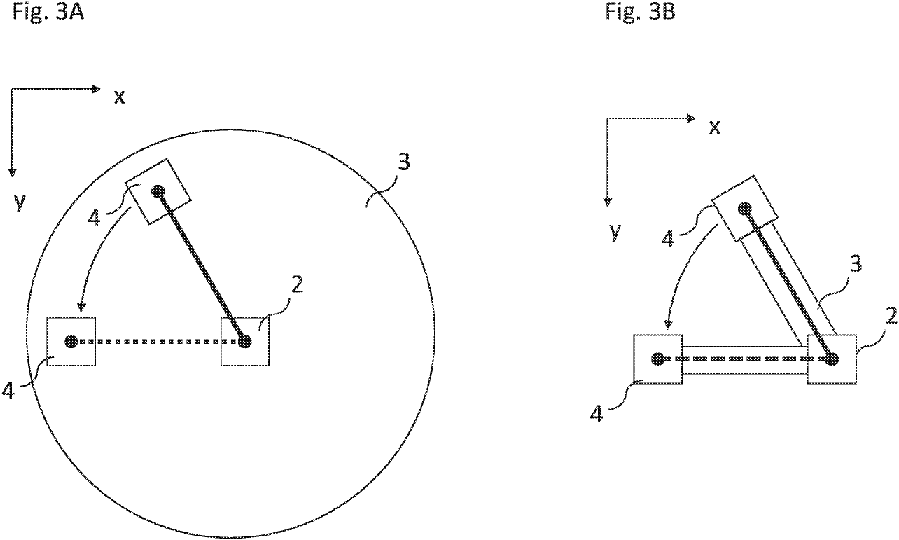

FIG. 3A shows a plan view, or bird’s eye view, of a cylindrical configuration of the rotary system 3, which in FIG. 2 is shown schematically with respect to the beam path. In other words, the rotary system 3 is in the form of a flat cylinder, in which the optical elements of the rotary system 3 are arranged. The laser beam 70 is introduced into the rotary system 3 via the input coupling system 2. The deflection optical unit 32 deflects the laser beam 70 into the plane of the rotary disc, the XY plane. The laser beam 70 is conducted through the rotary optical unit 30 and lastly introduced into the material 6 through the machining optical unit 4.

The cylinder of the rotary system 3 has a diameter considerably larger than its height, with the result that the cylinder can also be referred to as disc. The rotary optical unit 30 and the machining optical unit 4 can be mounted on or in the disc, or partially or completely integrated in it. Suitable balancing weights make it possible to compensate for a possible unbalance of the disc owing to the machining optical unit and optical components of the rotary optical unit 30.

FIG. 3B shows a bird’s eye view of an arm-shaped configuration of the rotary system 3. The arm-shaped rotary system 3 here is connected to the input-coupling system 2 so as to be able to rotate at one end of the arm. The mass of the arm-shaped rotary system 3 is typically much smaller than that of the cylindrical rotary system, but the unbalance in the arm-shaped rotary system 3 can be considerably larger. This can be overcome by the axis of rotation 34 running through the centre of gravity of the arm-shaped rotary system 3 and/or the arm-shaped rotary system 3 having a symmetrical form with respect to the axis of rotation 34 and having for example two mutually opposite machining optical units 4.

In both FIG. 3A and FIG. 3B, the entire rotary system rotates over the material 6, or the workpiece, that is arranged underneath it and is to be machined, this leading to a high path velocity at the location of the machining optical unit 4 and thus to a high machining velocity, or high throughput. The quick deflection system also makes it possible in spite of the high path velocity to deposit two successive pulses with a high repetition rate at the same position, provided that the displacement takes place by way of the rotation within the operating area.

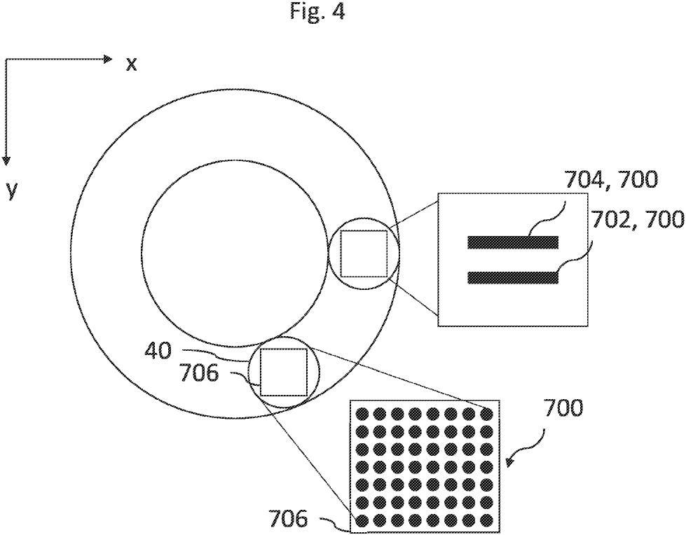

FIG. 4 shows the machining area 400, which can be obtained by means of the device 1 for machining the material without further relative displacement between the device 1 and the material 6. The machining area 400 can be understood here to mean the temporal overlap of the operating areas 706. The operating area 706 is arranged in particular in the machining plane of the machining optical unit 4.

The rotation of the rotary system 3 in conjunction with the initial deflection of the incident laser beam in the beam influencing system 22 makes it possible to traverse an operating area 400 which corresponds to a circular ring.

In other words, by virtue of the deflection by the beam influencing system 22, the operating area 400 corresponds not just to a simple circle with the radius R (as would have been obtained with a stationary machining optical unit 4), but rather an extended circular ring on the assumption of a round machining plane 40, which is largely filled by a square operating area 706. By means of the beam influencing system 22, the respective position of the pulse introduced into the material 6 can be influenced within the context of the deflection enabled by the beam influencing system 22 inside the corresponding operating area 706.

The beam influencing system 22 thus makes it possible to establish the position of each pulse within a small operating area 706 precisely for individual pulses and with a deflection rate of up to several megahertz (random access scan). The operating area here is for example between 2 and 500 focus diameters large, with the result that a relatively small change in position can be carried out, but with a very high velocity. It is thus possible, upon rotation of the rotary system 3 about the axis of rotation 34, to introduce the respective pulses or else pulse trains or bursts into the material 6 at the position schematically indicated by the operating area 706. Since the beam influencing unit 22 is very quick, it is correspondingly possible to achieve precise positioning of the focus in the material 6 during the rotation of the rotary system 3. It is thus possible firstly to enable very precise positioning of the respective foci in the material 6 and secondly also to increase the feed velocity of a relative movement between the device 1 and the material 6 while maintaining the same resolution.

The beam influencing system 22 also makes it possible to reach positions which, when there is a continuous feed between the device 1 and the material 6 owing to the constant movement of the device 1 and thus of the machining optical unit 4 in the feed direction, would not be able to be reached without the beam influencing system 22. The beam influencing system 22 may in this respect virtually also control points which might already lie “downstream”, in the feed direction, of the circle geometrically predefined by the machining optical unit 4.

In other words, the beam influencing system 22 makes it possible to introduce ultrashort laser pulses into the material 6 flexibly at the positions over which the circular ring sweeps, during the rotation of the rotary system 3.

By means of the beam influencing system 22, it is furthermore also or alternatively possible for the laser beam to be shaped such that the focal position in the machining plane 40 can also be varied. Therefore, it is also possible, for example, for the variation of the focal position in the machining plane 40 to be understood as shaping. In other words, by means of the beam influencing system 22 it is possible not just to achieve quick positioning in the x/y plane, but also quick positioning in the z direction, with the result that the use of the upstream beam influencing system 22 makes it possible to achieve flexible and precise utilization of the device 1.

The beam influencing system 22 also or alternatively makes it possible to influence the laser beam 70 such that its shape is modified. For example, the laser beam 70 may be split up into two partial laser beams 702, 704, with which it is then possible to machine the material 6 at the same time. In the example shown, the two partial laser beams have a linear beam profile, wherein the two beam profiles are aligned parallel to one another and one on top of the other.

The beam influencing system 22 also or alternatively makes it possible to generate what is referred to as a multispot intensity distribution, wherein a multiplicity of partial laser beams are generated. This structure corresponds, for example, to simultaneous occupation of all the positions in the schematically shown operating area 706. The partial laser beams that are generated may also have their shape modified individually, that is to say in terms of their beam cross section. For example, a first partial laser beam may have a rectangular beam cross section and another partial laser beam may have a round beam cross section.

Both the multispot intensity distribution and the linear beam profiles are machining geometries 700 that are introduced into the material.

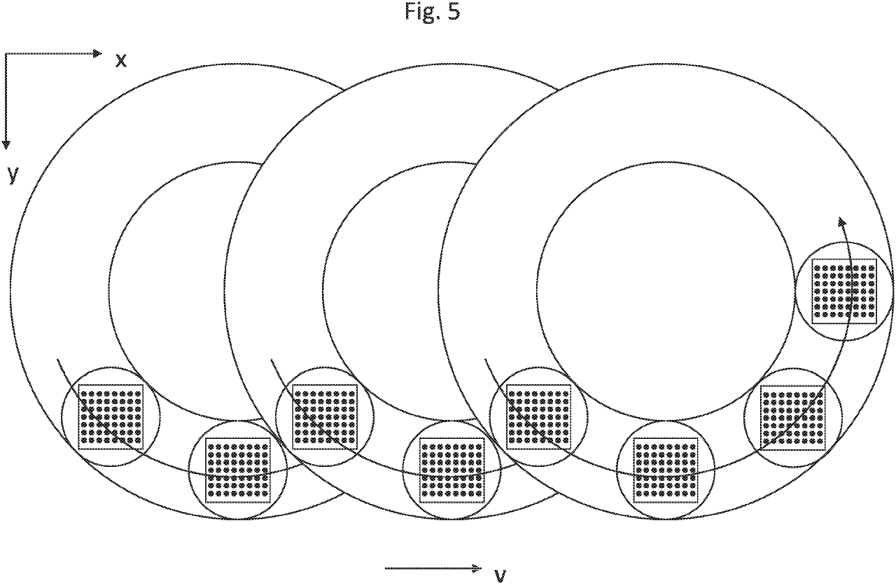

FIG. 5 by way of example illustrates a machining strategy for machining material 6 with the device 1. Synchronization of the input coupling system 2, in particular of the beam influencing system 22, of the rotary system 3 and of the ultrashort pulse laser 7, makes it possible also to adapt the current deflection by the beam influencing system 22, depending on the instantaneous position of the machining optical unit 4 in the circle segment.

In particular, the image is not conjointly rotated with the beam influencing system 22 by the adaptation, and therefore the machining geometry in the machining plane appears only offset or displaced. Microstructuring is thus flexible and is not linked to the rotating coordinate system, but rather is possible in the positionally fixed coordinate system of the material 6. In particular, the material 6 and the laser beam 70 may be displaced relative to one another during the machining.

As a result, extensive microstructures can be created by a combination of multiple axis movements, specifically by quick rotation about the axis of rotation 34 and the translational movement along the XYZ axes with the deflection of the laser beam 70 by the beam influencing unit 22 precisely for individual pulses.

To scale the surface area that is to be machined, with retention of the predefined numerical aperture, the focussing and the beam influencing system 22, preferably formed by an acousto-optic deflector unit, the radius R of the rotational movement can be increased with adaptation of the or by adding a further relay telescope, wherein typically the resolution in the machining plane and the ring thickness of the circular ring remain the same.

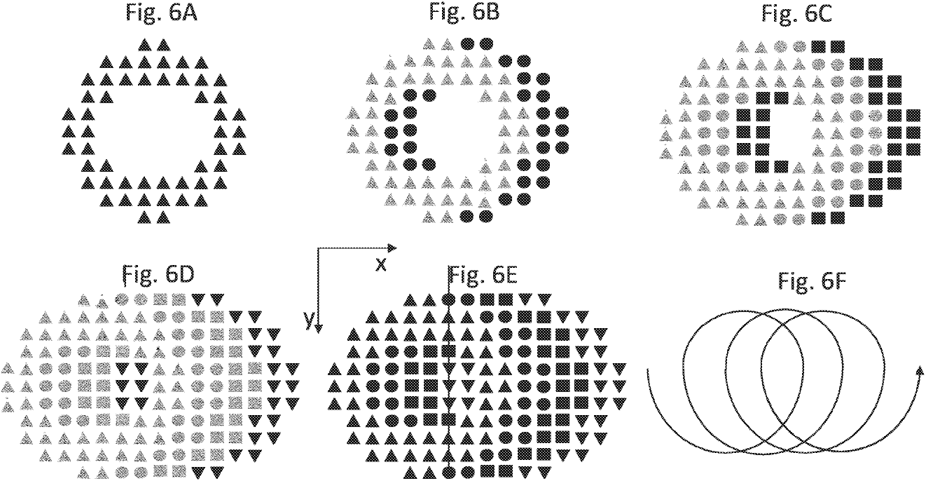

FIG. 6 shows a further detailed view of machining strategies.

In FIG. 6A, firstly laser beams 70 are introduced into the material along the circular ring, as a result of which the material 6 is for example microstructured (schematically indicated by black triangles). Each of the symbols can in turn be a multispot geometry in this respect. In the process, the device 1 and the material 6 are displaced relative to one another by means of a displacement device.

In FIG. 6B, the circular ring, and thus the region over which the laser beam 70 can sweep, has been displaced by the feed V along the x axis. The quick actuation of the beam influencing system 22 and the common time basis of the ultrashort pulse laser 7 with the rest of the system then make it possible to introduce laser pulses at those locations in the circular ring at which a laser pulse has not yet been introduced by the previous machining in FIG. 6A. Therefore, the machining of the material 6 during the pass with the feed is successively supplemented (schematically illustrated as black circles).

In FIG. 6C, the circular ring has been displaced again with the feed along the x axis. Once again, the previous machining steps (grey symbols) are supplemented by the laser pulses (schematically illustrated by black squares). In FIG. 6D, the circular ring is once again offset by the feed, with the last gaps in the preceding operating area being machined (black triangles).

FIG. 6E shows the final state of the machining. By virtue of the feed by the feed device 5 and the rotation of the rotary system 3 in combination with the quick positioning within the circular ring by the beam influencing system 22, it was possible to machine the material 7 over the entire surface area, with provision of a continuous feed and thus efficient machining. The machined surface area is independent of the selected circles and circular rings, since the machined surface areas are expanded and supplemented during the feed.

FIG. 6F shows the trajectory of the machining optical unit 4 that is produced as the feed device 5 is fed over the material 6. The superposed rotation about the axis of rotation with the feed results in a spiral shape. Along the spiral shape, within the available operating area of the machining optical unit 4, it is possible to introduce modifications of material, or microstructures, into the material 6.

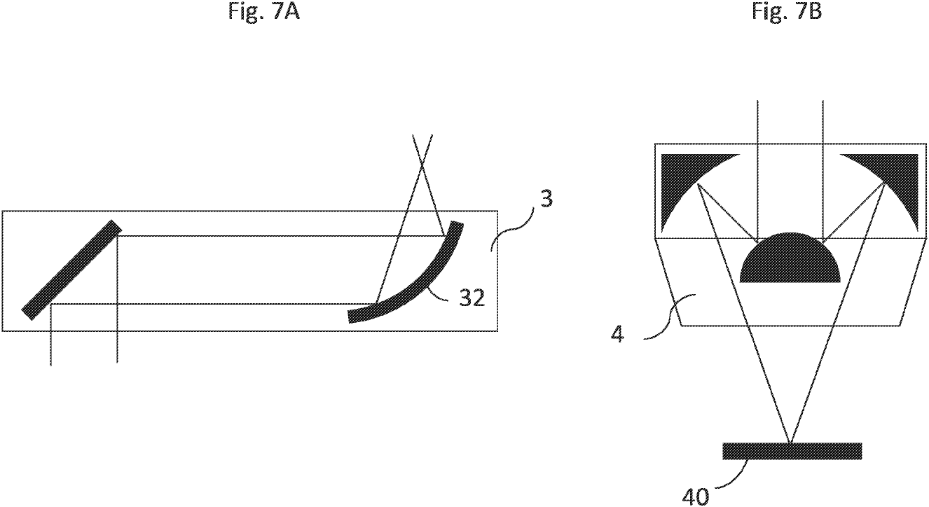

FIG. 7A shows a further embodiment of the rotary system 3. A rotary optical unit containing an imaging mirror 32 is fitted in the rotary system 3. The imaging, or curved, mirror 32 is a particular configuration of the deflection optical unit 32. This imaging of the beam in conjunction with the connected machining optical unit 4 makes it possible to generate an enlargement or a reduction in size of the machining geometry which is generated in the corresponding machining plane 42 by the beam influencing system 22.

Depending on the implementation of the deflection optical unit 32, the position of the corresponding machining plane 42 must be adapted, for example by a relay telescope 30, to achieve targeted imaging on the workpiece.

FIG. 7B shows a particular configuration of the machining optical unit 4. The machining optical unit 4 is in the form of a Schwarzschild objective lens here. A Schwarzschild objective lens consists of a combination of convex and concave mirrors. Ideally, the mirror systems have a rotationally symmetrical structure. The laser light is incident on a convex mirror through an opening in the concave mirror, to some extent through the rear side of the concave mirror. The convex mirror reflects the light back to the concave mirror, where it is reflected once again and deflected past the convex mirror into a focus. The reflection takes place in the focus of the Schwarzschild objective lens, with the imaging being provided by the properties of the curvature of the various mirror surfaces. The Schwarzschild objective lens is what is referred to as a mirror objective lens and allows the imaging of the corresponding machining plane 42 onto or into the material 6 without the light needing to pass through an optical element. This prevents the laser beam 70 from being absorbed in one of the fitted optical materials and is correspondingly suitable for particular wavelengths of the laser.

A Schwarzschild objective lens, however, has a image field curvature. If the Schwarzschild objective lens is to be used to realize a flat machining plane, the image field curvature must be pre-compensated. This can for example be done in the rotary optical unit or the beam influencing optical unit in that there, for example, a curved corresponding machining plane is made available by means of a suitable optical design.

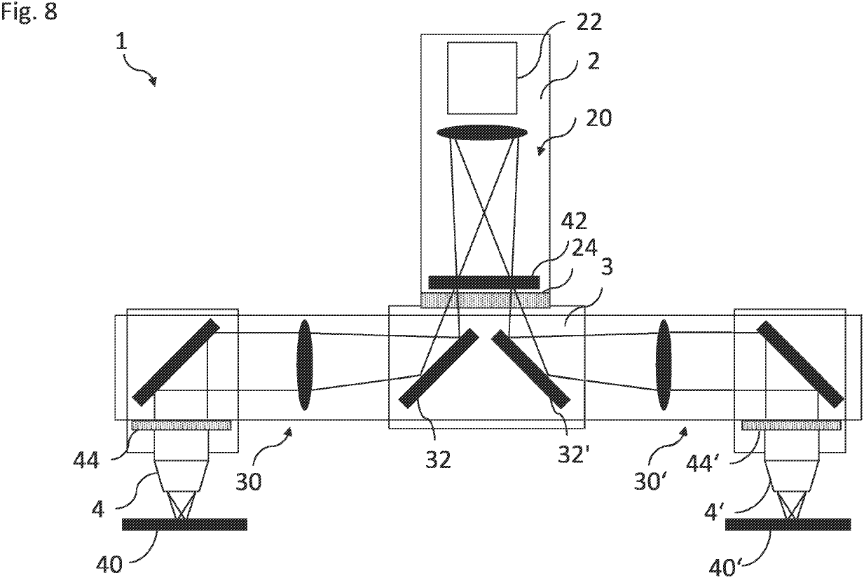

FIG. 8 shows a further variant of the device 1. By contrast to the structure from FIG. 2, the rotary system 3 only has a single beam path for the laser beam 70. Rather, a deflection optical unit comprising a plurality of mirrors 32, 32′ is used to realize a multiplicity of possible beam paths.

The beam influencing system 22 makes available for example two different partial laser beams or arrangements of partial laser beams. This can also be done by a possible division of the beam within the beam influencing system 22. A first arrangement of partial laser beams can in this respect be incident on the mirror 32, whereas another arrangement of partial laser beams is incident on the mirror 32′. Both arrangements are thus deflected by the deflection optical unit 32 to different beam paths, with the result that the different machining geometries are introduced into the material 6 via different machining optical units 4, 4′.

In particular, the deflection optical unit 32 may be realized as switchable. This means, for example, that only one specific machining geometry is introduced into the material 6 by each specific beam path of the rotary system 3. In particular, a switchable realization can also mean that a beam path into the rotary system 3 can be switched on or off, with the result that a certain machining geometry can be introduced only in the case of a particular angular alignment of the rotary system 3.

In particular, the laser beam 70 may be split up into multiple partial laser beams via control of the beam influencing system 22, preferably via control of the acousto-optic deflector unit 22, wherein the acousto-optic deflector unit 22 can deflect the respective partial beam onto one of the possible deflection optical units 32. For example, in the case of the structure shown in FIG. 8 with an acousto-optic deflector, a first beam half is conducted to the left-hand mirror 32 and then a second beam half is conducted to the right-hand mirror 32′.

The corresponding machining plane is therefore subdivided into a region imaged into the left-hand arm and a region imaged into the right-hand arm. The sizes of the parts of the corresponding machining plane that are accessible by the individual arms can be obtained by varying the acousto-optic deflector unit 22, for example by superposing a movement of a galvanometer scanner with the deflection of the acousto-optic deflector unit.

Thus, it is possible to quickly switch back and forth between the arms, and a radial offset carried along by the rotation can be compensated by jumping from one arm to the other.

In particular, it may also be the case that the laser beam is not split up into partial laser beams but rather a machining geometry is imposed on the laser beam 70 by the beam influencing system 22 and this machining geometry is conducted either to the mirror 32 or to the mirror 32′. Even if the rotary system 3 moves with a high angular velocity, the beam influencing system 22 in the form of an acousto-optic deflector unit makes it possible to ensure that the laser beam 70 is deflected into the desired beam path by the deflection optical unit 32.

The imposition illustrated in FIG. 8 may however also have the effect that the machining geometry provided by the beam influencing system 22 is merely duplicated by the deflection optical unit, with the result that the machining geometry is introduced into the material substantially at the same time via two different beam paths.

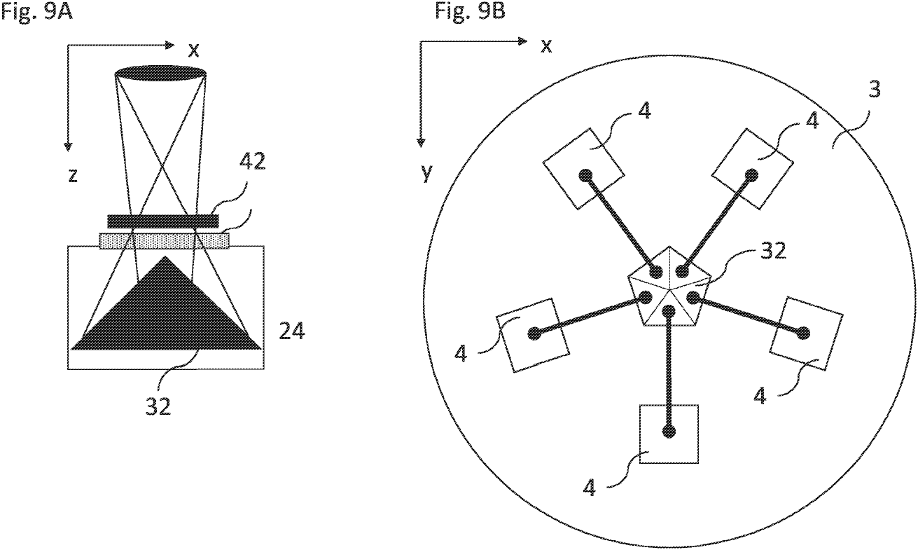

FIG. 9A shows a further form of the deflection optical unit 32. The deflection optical unit 32 may have a prism shape, with the prism surfaces being reflective, for example. In particular, the prism may have a multiplicity of reflective surfaces, with the number of reflective surfaces preferably corresponding to the number of possible beam paths of the rotary system 3.

FIG. 9B shows a further form of the rotary system 3. The rotary system 3 has a rotary optical unit 30, which has five beam paths. Each of the five beam paths leads into a dedicated machining optical unit 4, through which the machining geometry of the laser beam 70 can be imaged into or onto the material 6. For this purpose, the deflection optical unit 32 has a pentagonal outline, with the reflective surfaces of the deflection optical unit 32 resulting from the facets of the to some extent pentagonal, pyramidal shape of the deflection optical unit 32.

An acousto-optic deflector unit 22 can switch the laser beam 70 back and forth between the different machining arms, or beam paths, of the rotary system 3 and thus address a respective one of the machining optical units 4. In particular, multiple beam paths can be addressed simultaneously and not just sequentially, for example by virtue of quickly switched multispots. This means that multiple machining optical units 4 can be used to machine material at the same time.

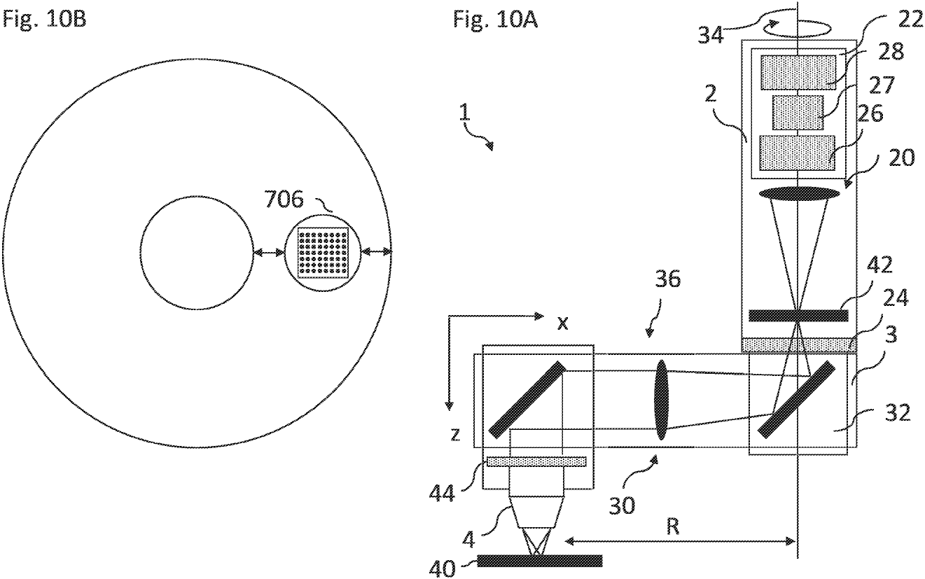

FIG. 10 shows an expanded variant of the device 1, wherein the beam influencing system 22 comprises an acousto-optic deflector unit 28, an imaging unit 27 and a galvanometer scanner 26. The acousto-optic deflector unit 28 deflects the incident laser beam 70, which is transferred to the galvanometer scanner by the imaging unit 27, wherein the galvanometer scanner 26 imposes an additional positional offset in the corresponding machining plane 42 on the laser beam 70. This enlarges the accessible operating area by means of the machining optical unit 4. In particular, as a result, a two-dimensional displacement of the imaging of the high-velocity scan field of the acousto-optic deflector unit 28 onto the material 6 can be brought about.

FIG. 10B shows a view of the circular ring, which can be addressed by the machining optical unit 4 of FIG. 10A, in the non-rotated coordinate system of the input coupling system. The galvanometer scanner 26 makes it possible to further enlarge the accessible circular ring.

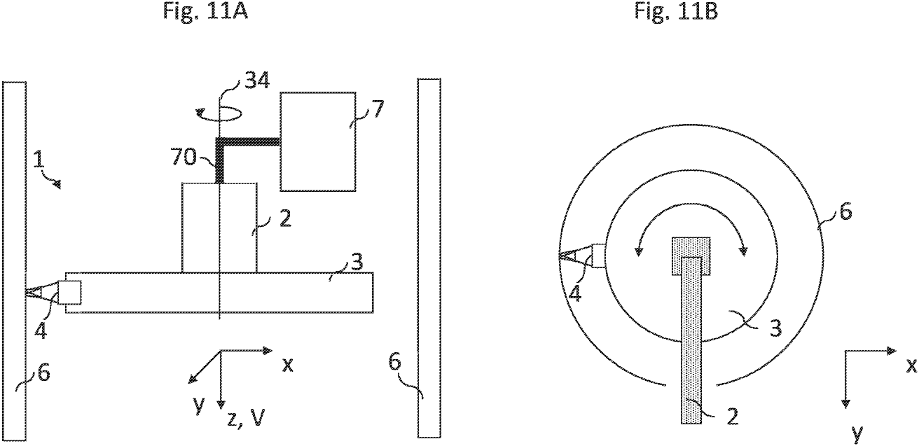

FIGS. 11A and B show a side view and a plan view of a device 1 which can be used to machine films 6. In this respect, for example, the films 6 may be wound up on a roll in a roll-to-roll process, be unwound for machining, and wound back up again to form a roll after the machining. The films 6 may in this respect in particular be drawn into a hollow-cylindrical shape for machining, with the axis of rotation largely coinciding, preferably exactly coinciding, with the cylinder axis. In particular, it is possible in this case for the feed V to be oriented along the cylinder axis, with the result that a one-dimensional movement of the device 1 along the cylinder axis combined with the roll-to-roll transport of the film makes it possible to machine the entire film 6.

In particular, in the present case a deflection of the laser beam 70 from the transfer from the rotary optical unit 3 to the machining optical unit 4 can be dispensed with, and therefore the machining operation can be carried out with an optically and mechanically more stable device 1.

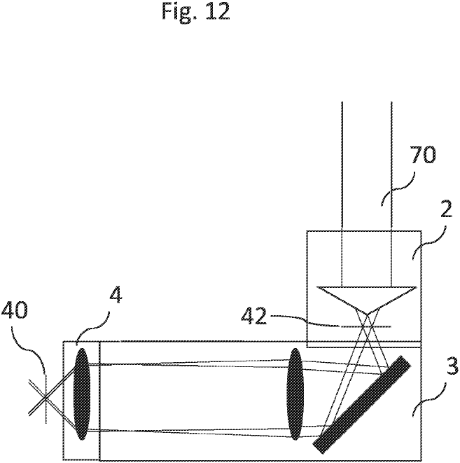

FIG. 12 shows a device 1 in which the beam influencing system 2 is an axicon. If the laser beam 70 passes through the axicon, a nondiffractive beam profile is imposed on the laser beam 70. In particular, in the present case the laser beam 70 is not deflected from the rotary optical unit 3 to the machining optical unit 4, with the result that the device 1 shown is suitable for machining materials 6 that are cylindrical at least in certain portions. However, it is also possible to use an axicon in another configuration of the device 1, for example that of FIGS. 1 to 10.

Insofar as applicable, all individual features presented in the exemplary embodiments can be combined with one another and/or interchanged, without departing from the scope of the invention.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

LIST OF REFERENCE SIGNS

| | |
|---|---|
| 1 | Device |
| 2 | Input coupling system |
| 20 | Input coupling optical unit |
| 22 | Beam influencing system |
| 24 | Connecting element |
| 26 | Galvanometer scanner |
| 27 | Imaging unit |
| 28 | Acousto-optic deflector unit |
| 3 | Rotary system |
| 30 | Rotary optical unit |
| 32 | Deflection optical unit |
| 34 | Axis of rotation |
| 36 | Telescope |
| 38 | Output coupling mirror |
| 4 | Machining optical unit |
| 40 | Machining plane |
| 400 | Machining area |
| 42 | Corresponding machining plane |
| 44 | Piezo shifter |
| 5 | Feed device |
| 6 | Material |
| 7 | Ultrashort pulse laser |
| 70 | Laser beam |
| 700 | Machining geometry |
| 702 | Partial laser beam |
| 704 | Partial laser beam |
| 706 | Operating area |
| 8 | Controller |

1. A device for machining a material using ultrashort laser pulses from a laser beam of an ultrashort pulse laser, the device comprising:
an input coupling system that is stationary in relation to an axis of rotation and comprises an input coupling optical unit for input coupling the laser beam,
a rotary system that is connected to the input coupling system so as to be rotatable about the axis of rotation and comprises a rotary optical unit, and
a machining optical unit that is connected to the rotary system and capable of being rotated together therewith, and is configured for guiding the laser beam into or onto the material to be machined,
wherein the input coupling optical unit is configured such that a laser beam input coupled into the input coupling optical unit is guided into a corresponding machining plane, and
wherein the rotary optical unit and the machining optical unit are configured such that the corresponding machining plane is guided into a machining plane of the material that is to be machined,
the device further comprising a beam influencing system for positioning and/or shaping the laser beam in the corresponding machining plane, wherein the beam influencing system is arranged upstream of and/or in the input coupling system.

2. The device according to claim 1, wherein a normal of the machining plane of the material is inclined by no more than 10° with respect to the axis of rotation.

3. The device according to claim 1, wherein a normal of the machining plane of the material is aligned substantially perpendicularly to the axis of rotation.

4. The device according to claim 1, wherein the beam influencing system enables a redistribution of an intensity distribution in the corresponding machining plane in such a way that a higher intensity is capable of being obtained in partial regions within the machining plane of the material than without the beam influencing system.

5. The device according to claim 1, wherein the beam influencing system comprises a beam shaping element and/or a beam positioning element, not arranged in the corresponding machining plane.

6. The device according to claim 1,wherein the beam influencing system comprises a beam shaping element and/or a beam positioning element, arranged in a region of the corresponding machining plane.

7. The device according to claim 1, wherein the laser is operated in a fundamental mode, and/or the laser beam is a coherent superposition of multiple modes of the laser, wherein a beam quality factor M² of the laser beam is less than 1.5.

8. The device according to claim 1, wherein the beam influencing system is configured to induce a coherent superposition of multiple partial laser beams.

9. The device according to claim 1, wherein the beam influencing system comprises an acousto-optic deflector unit.

10. The device according to claim 1, wherein the beam influencing system is configured such that positioning and/or shaping of the laser beam for each pulse is achieved in the corresponding machining plane, and/or focus positioning or beam shaping for each pulse is achieved in the machining plane of the material that is to be machined.

11. The device according to claim 1, wherein the machining optical unit comprises a high numerical aperture (NA) objective lens having a numerical aperture greater than 0.1,, or a Schwarzschild objective lens.

12. The device according to claim 11, wherein a focal position is capable of being adapted by a switchable function within the beam influencing system and/or by a focusing device comprising a piezo shifter.

13. The device according to claim 1, wherein the rotary system has an areal design in a form of a cylinder, or an arm-shaped design.

14. The device according to claim 1, wherein the rotary optical unit comprises imaging mirror and/or lens optical units.

15. The device according to claim 1, wherein the rotary optical unit comprises a telescope or parts of a telescope, wherein the telescope or parts of the telescope together with the machining optical unit images the corresponding machining plane of the input coupling system into the machining plane of the material, with a reduction in size.

16. The device according to claim 1, further comprising a feed device configured to displace the laser beam or the input coupling system with the rotary system, and the material relative to one another.

17. The device according to claim 1, further comprising a feed device configured to displace the input coupling system with the rotary system relative to the material parallel to the axis of rotation.

18. The device according to claim 1, wherein a radius of the rotary system is capable of being adapted, wherein the rotary optical unit is configured to compensate for the adaptation of the radius in the rotary system.

19. The device according to claim 1, wherein the rotary system comprises at least two rotary optical units connected to the machining optical unit, and the beam influencing system is configured to generate at least two machining geometries, each machining geometry being introduced into one of the two rotary optical units of the rotary system by a deflection optical unit.

20. The device according to claim 1, wherein the beam influencing system is configured to image a machining geometry into a scanner, wherein the scanner is configured to move the laser beam and images the laser beam in the corresponding machining plane.

21. The device according to claim 1, wherein the material is guided through the machining plane of the material in a roll-to-roll process.

22. The device according to claim 3, wherein the material is at least locally cylindrical, the axis of rotation substantially coincides with a cylinder axis, thereby the machining plane is adapted to a cylinder surface, and a feed is oriented parallel to the axis of rotation.
